(19) United States
(12) Patent Application Publication
(10) Pub. No.: US 2025/0305159 A1
(43) Pub. Date: Oct. 2, 2025

(54) METHOD FOR PRODUCING ELECTROLYTIC CELL UNIT AND ELECTROLYTIC CELL UNIT

(71) Applicant: TOKUYAMA CORPORATION, Shunan-shi, Yamaguchi (JP)

(72) Inventor: Hitoshi MATSUI, Shunan-shi (JP)

(73) Assignee: TOKUYAMA CORPORATION, Shunan-shi, Yamaguchi (JP)

(21) Appl. No.: 18/849,645

(22) PCT Filed: Mar. 1, 2023
(86) PCT No.: PCT/JP2023/007514

§ 371 Date: Sep. 23, 2024

(30) Foreign Application Priority Data
Mar. 25, 2022 (JP) 2022-050224

(51) Int. Cl. C25B 9/01; B23K 11/14; B23K 11/20; C25B 9/60

(52) U.S. Cl. CPC C25B 9/01; B23K 11/14; B23K 11/20; C25B 9/60

(57) ABSTRACT

There is provided a method for producing an electrolytic cell unit that can ensure improved welding quality. The method for producing an electrolytic cell unit includes: arranging a first rib 14 made of a first material, a first partition wall 12 made of the first material, a clad sheet 8 having a layer 8a of the first material and a layer 8b of the second material with lower electrical resistance than the first material, a second partition wall 28 made of the second material, and a second rib 30 made of a second material in this order, such that the first and second ribs 14, 30, the first and second partition walls 12, 28 and clad sheet 8 are arranged in this order; and joining the first and second ribs 14, 30, the first and second partition walls 12, 28, and the clad sheet 8 by resistance welding. The first rib 14 includes a first projection 64, and the second rib 30 includes a second projection 66. The first projection 64 and the second projection 66 vary in size.

### TECHNICAL FIELD

The present invention relates to a method for producing an electrolytic cell unit and an electrolytic cell unit.

### BACKGROUND ART

Patent Document 1 below discloses a method for producing an electrolytic cell unit, which is a component of a bipolar electrolytic cell for the electrolysis of an aqueous solution of alkali metal chloride to produce chlorine and alkali metal hydroxide.

According to this production method, initially, a partition member of titanium is arranged on the surface of a first partition wall (first pan) of titanium with a flange portion formed on its periphery, and is at least partially welded to the flange portion of the first partition wall, thereby forming a gas-liquid separation chamber. Similarly, a partition member of nickel is arranged on the surface of a second partition wall (second pan) of nickel with a flange portion formed on its periphery, and is at least partially welded to the flange portion of the second partition wall, thereby forming a gas-liquid separation chamber.

Then, a plurality of first ribs of titanium are arranged on the surface of the first partition wall. Further, a plurality of clad sheets, each having a two-layered structure with a titanium layer and a nickel layer, are arranged on the back side of the first partition wall at positions corresponding to the respective first ribs. The first partition wall and the second partition wall are allowed to overlap each other with their back sides facing each other, and a plurality of second ribs of nickel are arranged on the surface of the second partition wall at positions corresponding to the respective clad sheets.

Subsequently, the first ribs are joined to the surface of the first partition wall; the titanium layers of the clad sheets are joined to the back side of the first partition wall; the nickel layers of the clad sheets are joined to the back side of the second partition wall; and the second ribs are joined to the surface of the second partition wall. All of these members are joined simultaneously by resistance welding. Further, a frame member is placed in a space formed between the flange portion of the first partition wall and the flange portion of the second partition wall.

Patent Document 1 teaches that the production method disclosed therein can realize a reduction in the number of welding lacations, since the resistance welding of the first ribs, the first partition wall and the clad sheets can be performed simultaneously with the resistance welding of the second ribs, the second partition wall and the clad sheets by locating the first ribs and the clad sheets such that they face each other with the first partition wall sandwiched therebetween and locating the second ribs and the clad sheets such that they face each other with the second partition wall sandwiched therebetween.

### PRIOR ART DOCUMENT(S)

### Patent Document(s)

Patent Document 1: JP-A-2002-155388

### SUMMARY OF THE INVENTION

### Problems to be Solved by the Invention

However, the conventional method for producing an electrolytic cell unit has room for improvement in welding quality.

Since nickel has lower electrical resistance than titanium, a larger amount of heat is generated in the titanium members (i.e., the first partition wall, the first ribs and the titanium layers of the clad sheets) than in the nickel members (i.e., the second partition wall, the second ribs and the nickel layers of the clad sheets) during the resistance welding.

This makes it difficult to adjust the welding current in order to ensure adequate joint strength both between the titanium members and between the nickel members. A too low welding current does not melt the members sufficiently, resulting in inadequate joint strength. A too high welding current is highly likely to cause molten metal to explode and scatter, which is known as “expulsion and surface flash”. The occurrence of “expulsion and surface flash” leads to decreased welding strength and damage to the base materials. Further, since the molten base materials decrease in thickness through scattering, the resultant electrolytic cell for producing corrosive gas such as chlorine will be at increased risk of being damaged during operation. Furthermore, poor welding quality increases the structural resistance value of the resultant electrolytic cell during operation, resulting in an increase in electric power consumption rate.

It is an object of the present invention to provide a method for producing an electrolytic cell unit that can ensure improved welding quality, and an electrolytic cell unit that achieves an improvement in electric power consumption rate.

### Means for Solving the Problems

In order to achieve the above-described object, the present invention provides the following method for producing an electrolytic cell unit:

“A method for producing an electrolytic cell unit, comprising:
arranging a first rib made of a first material, a first partition wall made of the first material, a clad sheet having a layer of the first material and a layer of a second material with lower electrical resistance than the first material, a second partition wall made of the second material, and a second rib made of the second material in this order; and
joining the first rib, the first partition wall, the clad sheet, the second partition wall, and the second rib together by resistance welding, wherein
the first rib includes a first projection in a portion to be joined to the first partition wall, and the second rib includes a second projection in a portion to be joined to the second partition wall, and
the first projection and the second projection vary in size or number.”

Preferably, the first projection has a diameter larger than a diameter of the second projection. It is desirable that the first projection protrudes less than the second projection. It is preferred that the first projection is larger in number than the second projection.

It is suitable that the first rib has a larger thickness than the second rib. It is preferable that the first rib has a larger depth than the second rib. It is preferred that the first material is titanium. The second material may be nickel.

It is desirable that the diameter of the first projection is 1.05 times or more and 3.7 times or less larger than the diameter of the second projection. It is preferred that the first projection and the second projection are located such that a radial distance between a center of the first projection and a center of the second projection is within 15 mm. It is suitable that the resistance welding is performed at 350 or more and 550 or less points per square meter of an active electrode area during the above mentioned step of joining.

The present invention provides an electrolytic cell unit that achieves the above-described object, that is, an electrolytic cell unit produced by the above-described method for producing an electrolytic cell unit. The first projection forms into a weld mark with an area 1.15 times or more and 13.7 times or less larger than an area of a weld mark formed from the second projection.

Further, in an electrolytic cell unit produced by the above-described method for producing an electrolytic cell unit, the first projection and the second projection form into weld marks such that a radial distance between a center of the weld mark formed from the first projection and a center of the weld mark formed from the second projection is within 15 mm.

Furthermore, in an electrolytic cell unit produced by the above-described method for producing an electrolytic cell unit, the resistance welding is performed at 350 or more and 550 or less points per square meter of an active electrode area.

### Effects of the Invention

According to the production method of the present invention, the first projection formed on the first rib made of the first material and the second projection formed on the second rib made of the second material vary in size or number. This reduces the difference between the amount of heat generated in the members made of the first material and that in the members made of the second material with lower electrical resistance than the first material during welding. Thus, it becomes easier to adjust the welding current so that it can ensure adequate joint strength both between the members of the first material and between the members of the second material, and reduce the occurrence of “expulsion and surface flash”, in which molten base materials explode and scatter. Therefore, the production method of the present invention can ensure improved welding quality that is less likely to vary. Further, the electrolytic cell unit of the present invention can have a low structural resistance value, resulting in an improvement in electric power consumption rate.

### BRIEF DESCRIPTION OF THE DRAWINGS

FIG. 1: a plan view of an electrolytic cell unit produced by a method of the present invention;

FIG. 2: a cross-sectional view taken along the line A-A in FIG. 1;

FIG. 3: a partially enlarged cross-sectional view taken along the line B-B in FIG. 1;

FIG. 4: a cross-sectional view showing a state in which respective members are arranged in order;

FIG. 5: a cross-sectional view showing a state in which the respective members are arranged in order with more projections formed on a first rib than on a second rib; and

FIG. 6: a cross-sectional view showing a state in which the respective members are joined together.

### MODE FOR CARRYING OUT THE INVENTION

Hereinafter, an embodiment of a method for producing an electrolytic cell unit according to the present invention will be described with reference to the drawings.

### (Electrolytic Cell Unit 2)

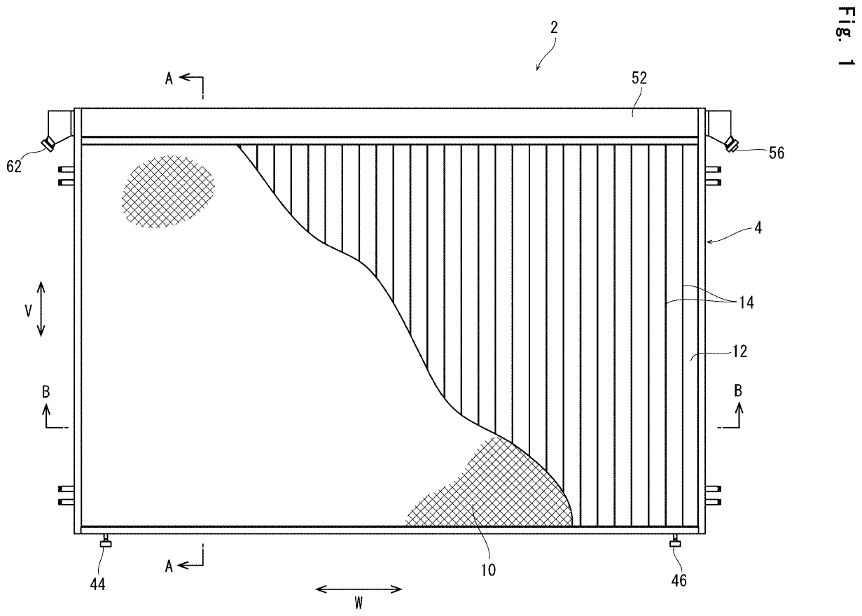

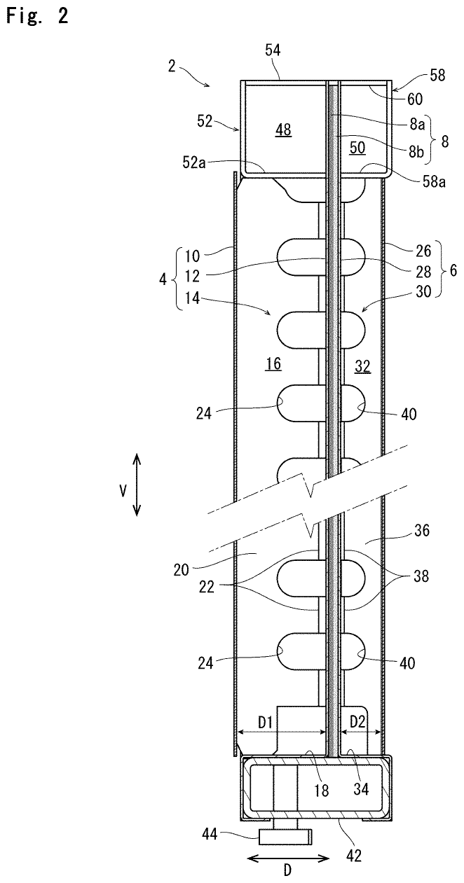

Referring to FIGS. 1 and 2, an electrolytic cell unit 2 that can be produced by the method of the present invention includes an anode chamber member 4 made of a first material, a cathode chamber member 6 (see FIG. 2) made of a second material with lower electrical resistance than the first material, and clad sheets 8 (see FIG. 2), each having a layer 8a of the first material and a layer 8b of the second material. The first material can be, for example, titanium (Ti), and the second material may be nickel (Ni).

### (Anode Chamber Member 4)

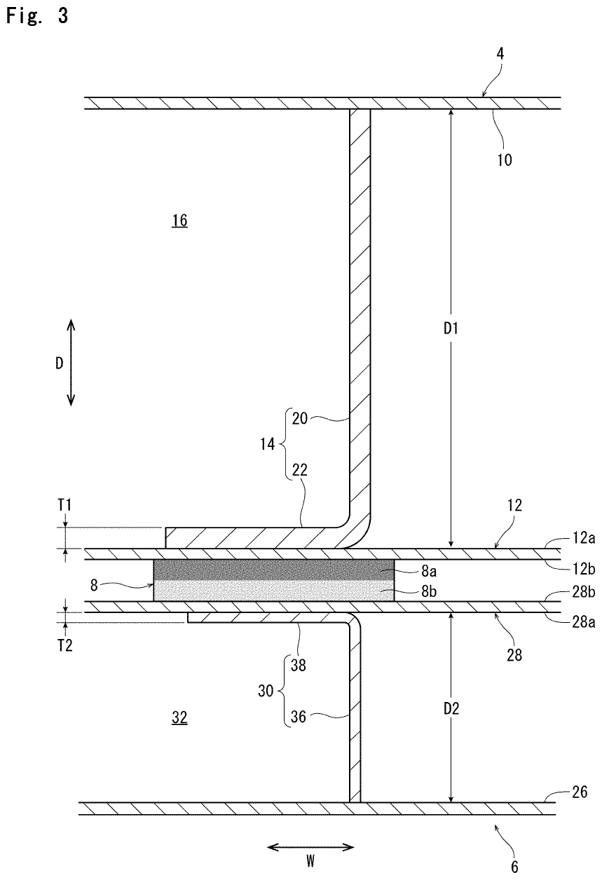

As shown in FIGS. 2 and 3, the anode chamber member 4 made of the first material (such as titanium) includes an anode plate 10, a first partition wall 12 arranged at a distance from the anode plate 10, and a plurality of first ribs 14 arranged between the anode plate 10 and the first partition wall 12.

### (Anode Plate 10)

The anode plate 10 with a rectangular shape includes a large number of openings not shown in drawings. The openings may have any shape, such as a diamond shape, a flat fan shape, or a slit shape. The large number of openings can be arranged in a staggered manner.

### (First Partition Wall 12)

The first partition wall 12 is arranged at a distance from the anode plate 10 in the depth direction (i.e., the direction D) indicated by an arrow D in FIG. 2. As shown in FIG. 2, a lower end side part of the first partition wall 12 is bent toward the lower end of the anode plate 10, thereby forming a bottom plate 18 that defines the lower end of an anode chamber 16. Although not shown in the drawings, both side parts of the first partition wall 12 in the width direction (i.e., the direction indicated by an arrow W in FIG. 1) are also bent toward the anode plate 10, thereby forming side walls that define end parts of the anode chamber 16 in the width direction.

### (First Rib 14)

As shown in FIG. 1, the plurality of first ribs 14 are provided at intervals in the width direction. Each of the first ribs 14 extend in the vertical direction (i.e., the direction V) indicated by an arrow V in FIG. 1. Referring to FIGS. 2 and 3, each of the first ribs 14 includes a main portion 20 extending from the anode plate 10 toward the first partition wall 12, and a plurality of joint pieces 22 protruding in the width direction from an end part of the main portion 20 on the first partition wall 12 side.

An end part of the main portion 20 on the anode plate 10 side is weld-joined to the anode plate 10. The joint pieces 22 are weld-joined to a surface 12a of the first partition wall 12. As will be understood from FIG. 2, the end part of the main portion 20 on the first partition wall 12 side includes a plurality of notches 24 provided at intervals in the vertical direction. Each of the notches 24 is located between the adjacent joint pieces 22. The plurality of notches 24 serve to ensure liquid and gas flows in the width direction in the anode chamber 16.

### (Cathode Chamber Member 6)

As shown in FIGS. 2 and 3, the cathode chamber member 6 of the second material (such as nickel) includes a current collector 26, a second partition wall 28 arranged at a distance from the current collector 26, and a plurality of second ribs 30 arranged between the current collector 26 and the second partition wall 28.

### (Current Collector 26)

The current collector 26 with a rectangular shape includes a large number of openings (not shown) just like the anode plate 10. The openings may have any shape, such as a diamond shape, a flat fan shape, or a slit shape. The large number of openings may be arranged in a staggered manner.

Although not shown in the drawings, a cathode plate is placed on the outer surface (i.e., the right surface in FIG. 2) of the current collector 26 via a metal buffer material, prior to assembling an electrolytic cell by arranging the electrolytic cell units 2 in large numbers in the depth direction and pressing them from both sides in the depth direction.

### (Second Partition Wall 28)

The second partition wall 28 is arranged at a distance from the current collector 26 in the depth direction (i.e., the direction D). As shown in FIG. 2, a lower end side part of the second partition wall 28 is bent toward the lower end of the current collector 26 just like the first partition wall 12, thereby forming a bottom plate 34 that defines the lower end of a cathode chamber 32. Although not shown in the drawings, both side parts of the second partition wall 28 in the width direction (i.e., the direction W) are also bent toward the current collector 26, thereby forming side walls that define end parts of the cathode chamber 32 in the width direction.

### (Second Rib 30)

The plurality of second ribs 30 are provided at intervals in the width direction to extend in the vertical direction (i.e., the direction V) just like the first ribs 14. As shown in FIG. 3, the plurality of second ribs 30 are arranged at positions corresponding to the respective plurality of first ribs 14. Each of the second ribs 30 includes a main portion 36 extending from the current collector 26 toward the second partition wall 28, and a plurality of joint pieces 38 protruding in the width direction from an end part of the main portion 36 on the second partition wall 28 side.

An end part of the main portion 36 on the current collector 26 side is weld-joined to the current collector 26. The joint pieces 38 are weld-joined to a surface 28a of the second partition wall 28. As will be understood from FIG. 2, the end part of the main portion 36 on the second partition wall 28 side includes a plurality of notches 40 provided at intervals in the vertical direction. Each of the notches 40 is located between the adjacent joint pieces 38. The plurality of notches 40 serve to ensure liquid and gas flows in the width direction in the cathode chamber 32.

FIG. 3 shows a dimensional relationship between the first rib 14 and the second rib 30. It is suitable that the first rib 14 has a thickness T1 larger than a thickness T2 of the second rib 30 (i.e., T1>T2). Further, it is preferable that the main portion 20 of the first rib 14 has a depth D1 larger than a depth D2 of the main portion 36 of the second rib 30 (i.e., D1>D2).

### (Clad Sheet 8)

Still referring to FIGS. 2 and 3, a plurality of the clad sheets 8 are provided at intervals in the width direction and extend in the vertical direction. The clad sheets 8 are arranged at positions corresponding to the respective joint pieces 22 of the first ribs 14 and the respective joint pieces 38 of the second ribs 30, between a rear surface 12b of the first partition wall 12 and a rear surface 28b of the second partition wall 28.

In the illustrated embodiment, each of the clad sheets 8 is formed of a two-layered sheet material in which the layer 8a of the first material (e.g., a titanium layer) and the layer 8b of the second material (e.g., a nickel layer) with lower electrical resistance than the first material are joined together by explosive cladding or rolling. The layer 8a made of the first material is weld-joined to the rear surface 12b of the first partition wall 12 of the first material. The layer 8b made of the second material is weld-joined to the rear surface 28b of the second partition wall 28 of the second material.

### (Supply Nozzles 44 and 46)

As shown in FIG. 2, a hollow lower frame 42 with a rectangular cross-section is provided in a lower part of the electrolytic cell unit 2. The lower frame 42 can be made of an appropriate metallic material such as stainless steel. The lower frame 42 has two through holes (not shown) penetrating in the vertical direction. A supply nozzle 44 for supplying a raw material to the anode chamber 16 is inserted in one of the through holes, and a supply nozzle 46 (see FIG. 1) for supplying a raw material to the cathode chamber 32 is inserted in the other through hole. Although not shown in the drawings, side frames are provided in both side end parts of the electrolytic cell unit 2 in the width direction.

### (Gas-Liquid Separation Chambers 48 and 50)

In an upper part of the electrolytic cell unit 2, an anode side gas-liquid separation chamber 48 and a cathode side gas-liquid separation chamber 50 are provided as shown in FIG. 2.

### (Anode Side Gas-Liquid Separation Chamber 48)

The anode side gas-liquid separation chamber 48 includes a partition member 52 made of the first material that is L-shaped in cross-section, and a rectangular top panel 54 made of the first material. The partition member 52 has a plurality of openings (not shown) that are formed at intervals in the width direction in its bottom portion 52a. The plurality of openings allow liquid and gas to flow vertically between the anode chamber 16 and the gas-liquid separation chamber 48.

As shown in FIG. 1, a discharge nozzle 56 for discharging gas and liquid in the gas-liquid separation chamber 48 is provided in an end part of the gas-liquid separation chamber 48 in the width direction. The discharge nozzle 56 is made of the first material.

### (Cathode Side Gas-Liquid Separation Chamber 50)

The cathode side gas-liquid separation chamber 50 includes a partition member 58 made of the second material that is L-shaped in cross-section, and a rectangular top panel 60 made of the second material. The partition member 58 has a plurality of openings (not shown) that are formed at intervals in the width direction in its bottom portion 58a. The plurality of openings allow liquid and gas to flow vertically between the cathode chamber 32 and the gas-liquid separation chamber 50.

A discharge nozzle 62 for discharging gas and liquid in the gas-liquid separation chamber 50 is provided in an end part (on the side opposite to the end part where the anode side discharge nozzle 56 is provided) of the gas-liquid separation chamber 50 in the width direction. The discharge nozzle 62 is made of the second material.

### (Method for Producing Electrolytic Cell Unit 2)

Next, a description will be given of a method for producing the above-described electrolytic cell unit 2.

First, the partition member 52, the top panel 54, and the discharge nozzle 56 are weld-joined to an upper part of the first partition wall 12, thereby forming the anode side gas-liquid separation chamber 48. Similarly, the partition member 58, the top panel 60, and the discharge nozzle 62 are weld-joined to an upper part of the second partition wall 28, thereby forming the cathode side gas-liquid separation chamber 50. Either the gas-liquid separation chamber 48 or the gas-liquid separation chamber 50 may be formed first.

### (Arrangement Step)

After the formation of the gas-liquid separation chambers 48 and 50, the Arrangement step is conducted to ensure that the first ribs 14, the first partition wall 12, the clad sheets 8, the second partition wall 28, and the second ribs 30 are arranged in this order.

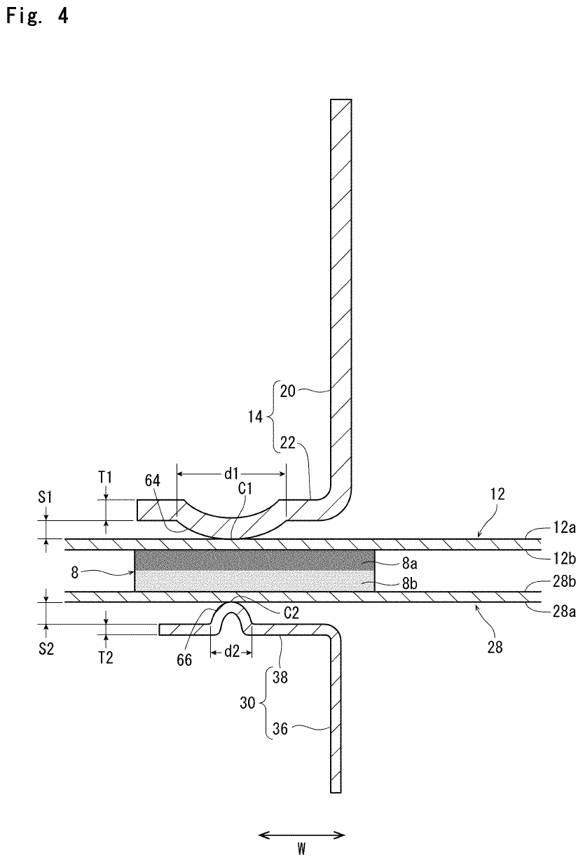

For example, in this arrangement step, the first ribs 14, the first partition wall 12, the clad sheets 8, the second partition wall 28, and the second ribs 30 can be arranged in this order from top to bottom as shown in FIG. 4.

Alternatively, the first ribs 14, the first partition wall 12, the clad sheets 8, the second partition wall 28, and the second ribs 30 may be arranged in this order from bottom to top in a direction opposite to that of FIG. 4.

In the arrangement step, each of the clad sheets 8 is arranged such that the layer 8a made of the first material faces the rear surface 12b of the first partition wall 12 made of the first material, while the layer 8b made of the second material faces the rear surface 28b of the second partition wall 28 made of the second material. Further, the joint pieces 22 of each of the first ribs 14, each of the clad sheets 8, and the joint pieces 38 of each of the second ribs 30 are located such that they are all in alignment in the width direction and the adjacent members come into contact with each other.

The first and second ribs 14 and 30, the first and second partition walls 12 and 28, and the clad sheets 8 may be arranged in any temporal order. The numbers of the first ribs 14, the second ribs 30 and the clad sheets 8 to be arranged may be one or more. However, when the plurality of first ribs 14, second ribs 30 and clad sheets 8 are arranged, they should be the same in number.

### (First and Second Projections 64 and 66)

As will be understood from FIG. 4, each of the joint pieces 22 (i.e., portions to be joined to the surface 12a of the first partition wall 12) of the first ribs 14 includes a first projection 64. Each of the joint pieces 38 (i.e., portions to be joined to the surface 28a of the second partition wall 28) of the second ribs 30 includes a second projection 66. Both the first and second projections 64 and 66 may have any shape, such as a circular shape or a rectangular shape.

In the illustrated embodiment, it is important that the first projection 64 and the second projection 66 vary in size or number.

For example, the first projection 64 and the second projection 66 may vary in size such that: the first projection 64 has a diameter d1 larger than a diameter d2 of the second projection 66 (i.e., d1>d2); or the first projection 64 protrudes by an amount S1 smaller than an amount S2 by which the second projection 66 protrudes (i.e., S1<S2).

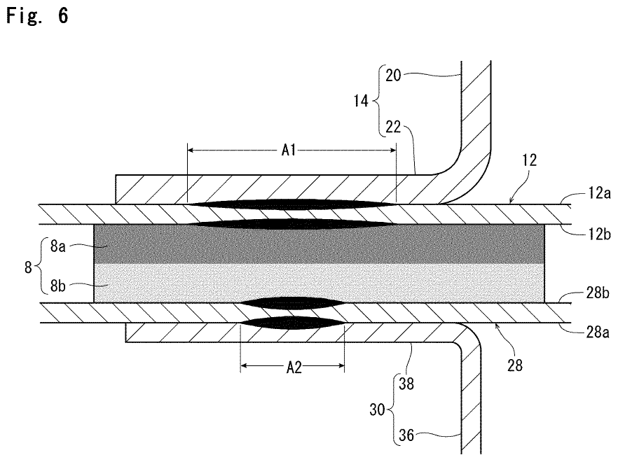

In a case where the diameter d1 of the first projection 64 is larger than the diameter d2 of the second projection 66, the diameter of the first projection 64 is desirably 1.05 times or more and 3.7 times or less, more desirably 1.05 times or more and 3.0 times or less, and particularly desirably 1.15 times or more and 2.5 times or less, larger than the diameter of the second projection 66. Consequently, in a joining step described later, the first projection 64 forms into a weld mark with an area A1 (see FIG. 6) equivalent to 1.15 times or more and 13.7 times or less, desirably 1.15 times or more and 6.8 times or less, and particularly desirably 1.15 times or more and 2.5 times or less, larger than an area A2 (see FIG. 6) of a weld mark formed from the second projection 66. As a result, the welded parts in the resultant electrolytic cell unit can have a low structural resistance value.

In general, the structural resistance value of a structure in which members are not welded together but only arranged in contact with each other is larger than the structural resistance value of a continuous structure in which members are welded together. Accordingly, if the weld mark area A1 resulting from the first projection 64 is less than 1.15 times larger than the weld mark area A2 resulting from the second projection 66, the structural resistance value of the welded parts between the first ribs 14, the first partition wall 12, the clad sheets 8, the second partition wall 28, and the second ribs 30 tends to increase due to the small welded area, which results in an increase in the structural resistance value of the electrolytic cell unit as a whole.

On the other hand, if the weld mark area A1 resulting from the first projection 64 is more than 13.7 times larger than the weld mark area A2 resulting from the second projection 66, increased thermal energy required for the welding causes thermal strain, so that the required electrode flatness accuracy deteriorates, leading to an increase in structural resistance value. In addition, the increased energy required for the welding also leads to reduced welding quality.

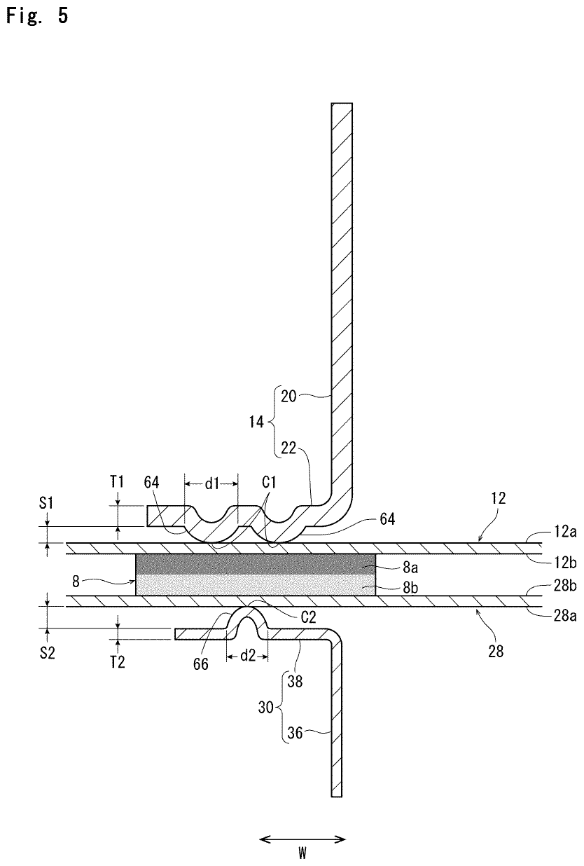

Alternatively, the first projection 64 and the second projection 66 may vary in number such that, for example: the first projection 64 is larger in number than the second projection 66 as shown in FIG. 5. As used herein, the number of the first projections 64 refers to the number of projections formed on each of the joint pieces 22 of the first ribs 14, and the number of the second projections 66 refers to the number of projections formed on each of the joint pieces 38 of the second ribs 30.

In the example shown in Figure S, the two first projections 64 are provided on each of the joint pieces 22 of the first ribs 14, while the single second projection 66 is provided on each of the joint pieces 38 of the second ribs 30. However, the numbers of the respective projections are not limited to those shown in FIG. 5 and can be set optionally.

In summary, the relationship between the first and second projections 64 and 66 with respect to size and number may be set to meet at least one of the following conditions 1 to 3:
1 The diameter d1 of the first projection 64 is larger than the diameter d2 of the second projection 66 (i.e., d1>d2);
2 The protrusion amount S1 of the first projection 64 is smaller than the protrusion amount S2 of the second projection 66 (i.e., S1<S2); and
3 The number of the first projections 64 is larger than the number of the second projections 66.

Two or all of the conditions 1 to 3 may be satisfied. FIG. 4 shows the case where the conditions 1 and 2 are satisfied, and FIG. 5 shows the case where all the conditions 1 to 3 are satisfied.

In the arrangement step, it is suitable that the radial distance (which is not a distance in the vertical direction V but rather a distance in the width direction W or the depth direction D) between a center C1 of the first projection 64 and a center C2 of the second projection 66 is within 15 mm. Consequently, in the electrolytic cell unit produced via the joining step described later, the radial distance between the center of the weld mark formed by the first projection 64 and the center of the weld mark formed by the second projection 66 is within 15 mm. This makes it possible to suppress the reactive current flowing along the first and second partition walls 12 and 18 (i.e., along a direction orthogonal to the thickness direction of the first and second partition walls 12 and 18) in the current pathway between the anode plate 10 and a cathode plate (not shown). As a result, the resultant electrolytic cell unit has a low resistance value between the anode plate 10 and the cathode plate.

### (Joining Step)

The arrangement step is followed by the joining step of joining the first ribs 14, the first partition wall 12, the clad sheets 8, the second partition wall 28, and the second ribs 30 by resistance welding. The resistance welding in the joining step may be spot welding.

In the joining step, one of the electrodes of a resistance welder (not shown) is brought into contact with the joint piece 22 of the first rib 14, while the other electrode is brought into contact with the joint piece 38 of the second rib 30, so that the first and second ribs 14 and 30, the first and second partition walls 12 and 28, and the clad sheet 8 are sandwiched between the paired electrodes of the resistance welder. Then, a predetermined pressure is applied to the respective members.

When a current is allowed to flow from the electrodes, Joule heat is generated due to electrical resistance, causing the first projection 64 and the second projection 66 to melt and collapse, whereby the joint piece 22 of the first rib 14 and the joint piece 38 of the second rib 30 are joined to the surface 12a of the first partition wall 12 and the surface 28a of the second partition wall 28, respectively, as shown in FIG. 6.

Further, the Joule heat generated due to electrical resistance when a current is applied also allows the rear surface 12b of the first partition wall 12 and the rear surface 28b of the second partition wall 28 to be joined to the layer 8a of the first material and the layer 8b of the second material, respectively, of the clad sheet 8.

In this joining step, it is suitable that the resistance welding is performed at 350 or more and 550 or less points per square meter of the active electrode area. If the resistance welding is performed at less than 350 points, the structural resistance value increases. If the resistance welding is performed at more than 550 points, the increased number of resistance welding points leads to reduced productivity, rather than effectively suppressing an increase in structural resistance value. The active electrode area as used herein refers to the area of a part of the electrode plate that actually contributes to electrolysis.

As described above, in the illustrated embodiment, the first projection 64 formed on each of the joint pieces 22 of the first material and the second projection 66 formed on each of the joint pieces 38 of the second material vary in size or number. This reduces the difference between the amount of heat generated in the members of the first material (i.e., the first partition wall 12, the first ribs 14, and the layers 8a of the first material of the clad sheets 8) and that in the members of the second material (i.e., the second partition wall 28, the second ribs 30, and the layers 8b of the second material of the clad sheets 8) with lower electrical resistance than the first material.

As a result, it become easier to adjust the welding current so that it can ensure adequate joint strength both between the members of the first material and between the members of the second material, and reduce the occurrence of “expulsion and surface flash”, in which molten base materials explode and scatter. Therefore, in the illustrated embodiment, it is possible to ensure improved welding quality that is less likely to vary.

After the joining step, the lower frame 42 is located in lower parts of the first and second partition walls 12 and 28 and weld-joined thereto. Then, the anode side supply nozzle 44 and the cathode side supply nozzle 46 are weld-joined to the lower frame 42.

Further, side frames are located in both side end parts of the first and second partition walls 12 and 28 in the width direction and weld-joined thereto. Then, the anode plate 10 is weld-joined to the end part of the main portion 20 of each of the first ribs 14, and the current collector 26 is weld-joined to the end part of the main portion 36 of each of the second ribs 30.

In the illustrated embodiment as described above, it is possible to reduce the difference between the amount of heat generated in the members made of the first material and that in the members made of the second material during the welding. Thus, the occurrence of expulsion at edge can be reduced, resulting in improved welding quality that is less likely to vary.

When the thickness T1 of the first ribs 14 is larger than the thickness T2 of the second ribs 30 (T1>T2) as in the illustrated embodiment, the difference between the amount of heat generation in the members of the first material and that in the members of the second material can be reduced even further, since the first material has higher electrical resistance than the second material. The same applies to the case where the depth D1 of the first ribs 14 is larger than the depth D2 of the second ribs 30 (D1>D2).

In addition, in a case where the first material is titanium and the second material is nickel, when the thickness T1 of the first ribs 14 is larger than the thickness T2 of the second ribs 30 made of the second material, or when the depth D1 of the first ribs 14 is larger than the depth D2 of the second ribs 30 made of the second material, it is possible to reduce the amount of the nickel members used while suppressing an increase in the structural resistance value of the electrolytic cell unit 2, thereby lowering the cost of the electrolytic cell unit 2.

### EXPLANATIONS OF LETTERS OR NUMERALS

2: Electrolytic cell unit
8: Clad sheet
8a: Layer of first material
8b: Layer of second material
12: First partition wall
14: First rib
28: Second partition wall
30: Second rib
64: First projection
66: Second projection

1. A method for producing an electrolytic cell unit, comprising:
arranging a first rib made of a first material, a first partition wall made of the first material, a clad sheet having a layer of the first material and a layer of a second material with lower electrical resistance than the first material, a second partition wall made of the second material, and a second rib made of the second material in this order; and
joining the first rib, the first partition wall, the clad sheet, the second partition wall, and the second rib together by resistance welding, wherein
the first rib includes a first projection in a portion to be joined to the first partition wall, and the second rib includes a second projection in a portion to be joined to the second partition wall, and
the first projection and the second projection vary in size or number.

2. The method for producing an electrolytic cell unit according to claim 1, wherein the first projection has a diameter larger than a diameter of the second projection.

3. The method for producing an electrolytic cell unit according to claim 1, wherein the first projection protrudes less than the second projection.

4. The method for producing an electrolytic cell unit according to claim 1, wherein the first projection is larger in number than the second projection.

5. The method for producing an electrolytic cell unit according to claim 1, wherein the first rib has a larger thickness than the second rib.

6. The method for producing an electrolytic cell unit according to claim 1, wherein the first rib has a larger depth than the second rib.

7. The method for producing an electrolytic cell unit according to claim 1, wherein the first material is titanium.

8. The method for producing an electrolytic cell unit according to claim 1, wherein the second material is nickel.

9. The method for producing an electrolytic cell unit according to claim 2, wherein the diameter of the first projection is 1.05 times or more and 3.7 times or less larger than the diameter of the second projection.

10. The method for producing an electrolytic cell unit according to claim 1, wherein the first projection and the second projection are located such that a radial distance between a center of the first projection and a center of the second projection is within 15 mm.

11. The method for producing an electrolytic cell unit according to claim 1, wherein the resistance welding is performed at 350 or more and 550 or less points per square meter of an active electrode area in the step of joining.

12. An electrolytic cell unit produced by the method for producing an electrolytic cell unit according to claim 2, wherein the first projection forms into a weld mark with an area 1.15 times or more and 13.7 times or less larger than an area of a weld mark formed from the second projection.

13. An electrolytic cell unit produced by the method for producing an electrolytic cell unit according to claim 1, wherein the first projection and the second projection form into weld marks such that a radial distance between a center of the weld mark formed by the first projection and a center of the weld mark formed by the second projection is within 15 mm.

14. An electrolytic cell unit produced by the method for producing an electrolytic cell unit according to claim 1, wherein the resistance welding is performed at 350 or more and 550 or less points per square meter of an active electrode area.

15. The method for producing an electrolytic cell unit according to claim 2, wherein the first projection protrudes less than the second projection.

16. The method for producing an electrolytic cell unit according to claim 2, wherein the first projection is larger in number than the second projection.

17. The method for producing an electrolytic cell unit according to claim 3, wherein the first projection is larger in number than the second projection.

18. The method for producing an electrolytic cell unit according to claim 2, wherein the first rib has a larger thickness than the second rib.

19. The method for producing an electrolytic cell unit according to claim 3, wherein the first rib has a larger thickness than the second rib.

20. The method for producing an electrolytic cell unit according to claim 4, wherein the first rib has a larger thickness than the second rib.
